(19) United States
(12) Patent Application Publication
(10) Pub. No.: US 2025/0381851 A1
(43) Pub. Date: Dec. 18, 2025

(54) MOTOR DRIVING APPARATUS AND METHOD FOR CONTROLLING THE SAME

(71) Applicants: HYUNDAI MOTOR COMPANY, SEOUL (KR); KIA CORPORATION, SEOUL (KR)

(72) Inventors: Ho Rim CHOI, Hwaseong-si (KR); Sang Woo PARK, Hwaseong-si (KR); Tae Jun MOON, Hwaseong-si (KR); Tae Il YOO, Hwaseong-si (KR); Jin Wook KANG, Hwaseong-si (KR)

(21) Appl. No.: 18/955,793

(22) Filed: Nov. 21, 2024

(30) Foreign Application Priority Data
Jun. 12, 2024 (KR) 10-2024-0076470

(51) Int. Cl. B60L 15/02; B60L 15/20

(52) U.S. Cl. CPC B60L 15/025; B60L 15/20; B60L 2210/40; B60L 2240/12; B60L 2240/24; B60L 2240/423; B60L 2240/463; B60L 2240/647

(57) ABSTRACT

Disclosed herein is a motor driving apparatus, which includes a first motor and a second motor, each independently driving a left wheel and a right wheel of a vehicle, a first inverter unit driving the first motor and a second inverter unit driving the second motor, and a controller performing torque vectoring to drive the left wheel and the right wheel with different torques by adjusting a torque command for at least one of the first motor and the second motor, and a method for controlling the same.

### CROSS REFERENCE TO RELATED APPLICATION

The present application claims priority of Korean Patent Application No. 10-2024-0076470 filed on Jun. 12, 2024, the entire contents of which is incorporated herein for all purposes by this reference.

### BACKGROUND

### Field

The present disclosure relates to a motor driving apparatus and a method for controlling the same, which may enhance torque vectoring performance in a high-speed range.

### Description of Related Art

In general, a torque vectoring system refers to a system that independently and freely adjusts a magnitude of torque transmitted to left and right wheels of a vehicle. Such a torque vectoring system enables different torques to be applied to each rotating wheel, thereby reducing wheel slip in a driving situation and enhancing driving stability and performance.

For example, during cornering on a curved road, the system applies additional power to an outer wheel of the vehicle and brakes an inner wheel of the vehicle, thereby enabling smooth cornering of the vehicle.

With the recent growing interest in the environment, the number of eco-friendly vehicles equipped with electric motors as a power source has increased. Eco-friendly vehicles are also known as electrified vehicles, and typical examples include hybrid electric vehicles (HEVs) and electric vehicles (EVs).

Such electrified vehicles have relatively precisely controllable motors as a power source, making it possible to implement a more precise torque vectoring system compared to internal combustion engine vehicles that only have engines as a driving power source.

The foregoing is intended merely to aid in the understanding of the background of the present disclosure, and is not intended to mean that the present disclosure falls within the purview of the related art that is already known to those skilled in the art.

### SUMMARY

One objective of the present disclosure is to provide a motor driving apparatus and a method for controlling the same, which may improve torque vectoring performance in a high-speed range by adjusting an output limit of a motor during torque vectoring control.

Technical objectives of the present disclosure are not limited to the technical objectives mentioned above, and other technical objectives not mentioned above will be clearly understood by those skilled in the art from the following description.

According to an embodiment of the present disclosure, there is provided a motor driving apparatus, which includes: a first motor and a second motor, each independently driving a left wheel and a right wheel of a vehicle; a first inverter unit driving the first motor through at least one inverter and a second inverter unit driving the second motor through at least one inverter; and a controller controlling the first inverter unit and the second inverter unit based on a torque command and an output limit for each of the first motor and the second motor, wherein the controller performs torque vectoring to drive the left wheel and the right wheel with different torques by adjusting the torque command for at least one of the first motor and the second motor.

According to another embodiment of the present disclosure, there is provided a method for controlling a motor driving apparatus, which includes: controlling, by a controller, a first inverter unit driving a first motor through at least one inverter and a second inverter unit driving a second motor through at least one inverter based on a torque command and an output limit for each of the first motor and the second motor, each independently driving a left wheel and a right wheel of a vehicle; and performing torque vectoring, by the controller, to drive the left wheel and the right wheel with different torques by adjusting the torque command for at least one of the first motor and the second motor.

According to various embodiments of the present disclosure as described above, torque vectoring may be implemented without a separate device for controlling torque vectoring by driving the left and right wheels of the vehicle separately through the plurality of motors.

In particular, by adjusting the output limit of the motor itself, torque vectoring may be performed normally without a separate device even in a situation requiring high output, thereby improving steering control performance of the vehicle.

The effects which may be achieved in the present disclosure are not limited to the effects mentioned above, and other effects not mentioned above will be clearly appreciated from the following description by those skilled in the art.

### BRIEF DESCRIPTION OF THE DRAWINGS

FIG. 1 is a view showing a configuration of a motor driving apparatus according to an embodiment of the present disclosure.

FIG. 2 is a view showing an output limit curve of a motor according to an embodiment of the present disclosure.

FIG. 3 is a view showing a torque limit curve of the motor according to an embodiment of the present disclosure.

FIG. 4 is a view showing a detailed configuration of a controller according to an embodiment of the present disclosure.

FIG. 5 is a flowchart describing a method for controlling the motor driving apparatus according to an embodiment of the present disclosure.

### DETAILED DESCRIPTION

Specific structural and functional descriptions of embodiments of the present disclosure disclosed herein have been illustrated merely for the purpose of describing embodiments according to the present disclosure. Embodiments according to the present disclosure may be implemented in various forms, and thus should not be construed as being limited to embodiments described herein.

Embodiments according to the present disclosure are subject to various modifications and may have many forms, and thus certain embodiments will be illustrated by way of example in the accompanying drawings and described in detail in the present specification or application. It should be understood, however, that this is not intended to limit the embodiments according to the inventive concepts of the present disclosure to specific forms of embodiments, but the embodiments include all modifications, equivalents, and substitutes included in the spirit and scope of the present disclosure.

Unless otherwise defined, all terms used herein, including technical or scientific terms, shall have the same meaning as commonly understood by those skilled in the art. It will be further understood that terms, such as those defined in commonly used dictionaries, should be interpreted as having a meaning consistent with their meaning in the context of the relevant art, and shall not be construed to have an idealized or unduly formal meaning unless expressly so defined herein.

Hereinafter, embodiments disclosed herein will be described in detail with reference to the drawings. The same reference numerals are given to the same or similar components regardless of reference numerals, and a repetitive description thereof will be omitted.

In the description of the following embodiments, when a parameter is referred to as being “preset,” it may be intended to mean that a value of the parameter is predetermined when the parameter is used in a process or an algorithm. The value of the parameter may be set at the start of the process or the algorithm, or may be set during the execution of the process or the algorithm, depending on the embodiment.

As used in the following description, suffixes “module” and “part” for a component are used or interchangeably used solely for ease of preparation of the specification, and do not have different meanings and each of them does not function by itself.

In describing embodiments disclosed herein, when a detailed description of a known related art is determined to obscure the gist of the present specification, the detailed description thereof will be omitted herein. In addition, the accompanying drawings are merely for easy understanding of the embodiments disclosed herein, and the technical spirit disclosed herein is not limited by the accompanying drawings, and it should be understood to include all modifications, equivalents, and substitutes included in the spirit and scope of the present disclosure.

Terms including ordinal numbers such as first, second, and the like used herein may be used to describe various components, but the various components are not limited by these terms. The terms are used only for the purpose of distinguishing one component from another component.

When a component is referred to as being “connected” or “coupled” to another component, the component may be directly connected or coupled to another component, but it should be understood that still another component may be present between the component and another component. Conversely, when a component is referred to as being “directly connected” or “directly coupled” to another, it should be understood that still another component may not be present between the component and another component.

Unless the context clearly dictates otherwise, the singular form includes the plural form.

The terms “comprising,” “having,” or the like as used herein are used to specify that a feature, a number, a step, an operation, a component, an element, or a combination thereof described herein exists, and they do not preclude the presence or addition of one or more other features, numbers, steps, operations, components, elements, or combinations thereof.

In addition, a unit or control unit included in names such as a motor control unit (MCU), a vehicle control unit (VCU), and a hybrid control unit (HCU) is only a term widely used in the naming of a controller that controls the specific function of a vehicle, but does not mean a generic function unit.

A controller may include a communication device for communicating with other control units or sensors to control a responsible function, a memory for storing an operating system, a logic command, and input/output information, and one or more processors for performing determination, calculation, and decision which are necessary for controlling the responsible function.

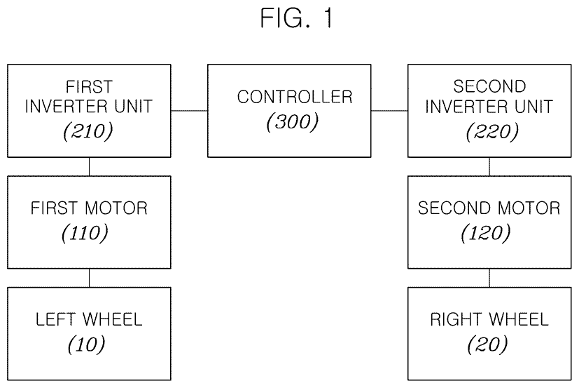

A motor driving apparatus and a method for controlling the same perform torque vectoring by independently driving left and right wheels of a vehicle through a plurality of motors, and, in particular, to improve torque vectoring performance by adjusting an output limit of the motors according to a torque command adjusted through torque vectoring. Before describing the method for controlling the motor driving apparatus, a configuration of the motor driving apparatus will first be described below with reference to FIGS. 1 to 4.

FIG. 1 is a view showing a configuration of a motor driving apparatus according to an embodiment of the present disclosure.

Referring to FIG. 1, the motor driving apparatus includes a first motor 110, a second motor 120, a first inverter unit 210, a second inverter unit 220, and a controller 300.

First, the first motor 110 and the second motor 120 each independently drive a left wheel 10 and a right wheel 20 of the vehicle. In this case, the left wheel 10 and the right wheel 20 may each refer to at least one wheel. More specifically, the first motor 110 is connected to the left wheel 10 to drive the left wheel 10, and the second motor 120 is connected to the right wheel 20 to drive the second motor 120 independently of the first motor 110.

The first inverter unit 210 and the second inverter unit 220 each drive the first motor 110 or the second motor 120 through at least one inverter. More specifically, the first inverter unit 210 is connected to the first motor 110 to drive the first motor 110, and the second inverter unit 220 is connected to the second motor 120 to drive the second motor 120.

Meanwhile, the controller 300 controls the first inverter unit 210 and the second inverter unit 220 based on a torque command and an output limit for each of the first motor 110 and the second motor 120. That is, the controller 300 may control the first motor 110 and the second motor 120 to output a required torque under the output limit by converting power through the first inverter unit 210 and the second inverter unit 220.

In particular, the controller 300 may perform torque vectoring to drive the left wheel 10 and the right wheel 20 with different torques by adjusting the torque command for at least one of the first motor 110 and the second motor 120. For example, when existing torque commands for the first motor 110 and the second motor 120 are identical, the controller 300 may adjust the torque commands for one or both of the first motor 110 and the second motor 120 considering various conditions, thereby causing the first motor 110 and the second motor 120 to output different torques. As a result, the left wheel 10 and the right wheel 20, driven by the first motor 110 and the second motor 120, respectively, may be driven with different torques.

Here, various conditions considered for torque vectoring may include at least one of a torque command according to a required output of the vehicle, a steering angle of the vehicle, and a speed of the vehicle. That is, the controller 300 may perform torque vectoring by adjusting the torque command based on the torque command according to the required output, the steering angle, and the speed of the vehicle. In this case, a motor for which the torque command is adjusted, a degree or direction of the torque command adjustment, and the like may be determined based on a combination of the torque command, the steering angle, and the speed of the vehicle.

Furthermore, the controller 300 may adjust the torque command by considering not only conditions based on a state of the vehicle itself, such as the torque command, the steering angle, and the speed of the vehicle mentioned above, but also a surface condition of a road on which the vehicle is driving. In this case, the controller 300 may acquire the surface condition of the road being driven on through external communication, or may retrieve information corresponding to a current location from previously stored information about the road surface condition and utilize the retrieved information for torque vectoring.

Meanwhile, in order to smoothly perform torque vectoring, the controller 300 may adjust the output limit for the first motor 110 based on the torque command adjusted through torque vectoring and a present output limit for the first motor 110. In this case, the controller 300 may increase the output limit for the first motor 110 if the torque command adjusted through torque vectoring exceeds the present output limit.

Similarly, the controller 300 may adjust the output limit for the second motor 120 based on the torque command adjusted through the torque vectoring and the present output limit for the second motor 120, and may increase the output limit for the second motor 120 if the torque command adjusted through torque vectoring exceeds the present output limit.

In addition, the controller 300 may determine whether to increase the output limit only for a motor for which the torque command is adjusted upward through torque vectoring among the first motor 110 and the second motor 120, and may increase the output limit based on a determination result.

That is, the controller 300 may determine whether to adjust the output limit separately for each of the first motor 110 and the second motor 120 and then perform the adjustment. However, a situation that requires the adjustment of the output limit is mostly when the torque command is adjusted upward. Thus, the controller 300 may determine whether to increase the output limit based on the adjusted torque command and a present output limit for a motor for which the torque command is adjusted upward based on a torque vectoring result; and if the adjusted torque command exceeds the present output limit, the controller 300 may increase the output limit for the motor concerned. In this case, the torque command may not be adjusted based on the torque vectoring result, or the determination or control of output limit adjustment may be omitted for the motor with a decreased output limit.

The increased output limit may be maintained for a preset period of time, and when the preset period of time elapses, the increased output limit may be restored to a level before the increasing. That is, as an increase in the torque command according to torque vectoring is generally required temporarily in a cornering situation, an increase in the output limit may also be temporarily performed. In this case, a period of time for which the output limit is increased may be set differently depending on the embodiment, and may be set for each vehicle type, or may be set in response to a driver's input. In contrast, depending on the embodiment, the increase in the output limit may be maintained while the torque command adjusted upward according to torque vectoring exceeds an existing output limit regardless of the preset period of time.

In addition, the controller 300 may increase the output limit when output limit increase conditions, including an output limit increase allowance setting, are satisfied, independent of whether the torque command adjusted according to torque vectoring exceeds a present output limit. In this case, the output limit increase allowance setting may be set by a vehicle user, such as a driver, and may be input through an Audio Video Navigating Telematics (AVNT) device, a cluster, or the like, which is provided inside the vehicle and capable of transmitting signals to the controller 300. In addition, whether output limit increase conditions are satisfied may be determined by further considering the durability, heat generation, present controllability of a motor and an inverter and a state of charge (SOC) of a battery connected to the motor and the inverter, and the like.

Meanwhile, the first inverter unit 210 and the second inverter unit 220 may each include a plurality of inverters, and may drive the first motor 110 and the second motor 120, respectively, through one or all of the plurality of inverters based on a drive mode of each of the first motor 110 and the second motor 120.

More specifically, the drive modes include a first drive mode in which a motor is driven through one of the plurality of inverters, and a second drive mode in which a motor is driven through all of the plurality of inverters. Here, the first drive mode may be referred to as a closed-end winding (CEW) mode, and the second drive mode may be referred to as an open-end winding (OEW) mode.

When the first motor 110 is driven in the first drive mode, the first inverter unit 210 drives the first motor 110 through one of the plurality of inverters. When the first motor 110 is driven in the second drive mode, the first inverter unit 210 may drive the first motor 110 through all of the plurality of inverters. Similarly, when the second motor 120 is driven in the first drive mode, the second inverter unit 220 drives the second motor 120 through one of the plurality of inverters. When the second motor 120 is driven in the second drive mode, the second inverter unit 220 may drive the second motor 120 through all of the plurality of inverters.

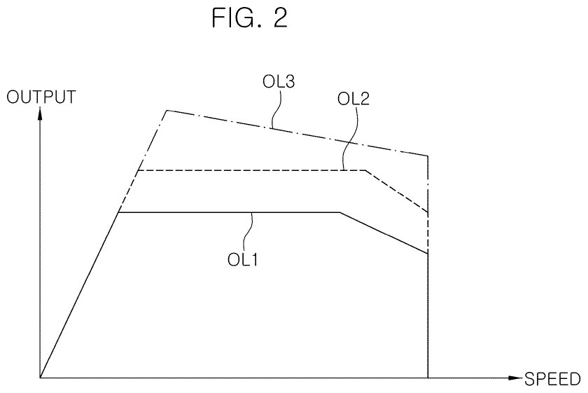

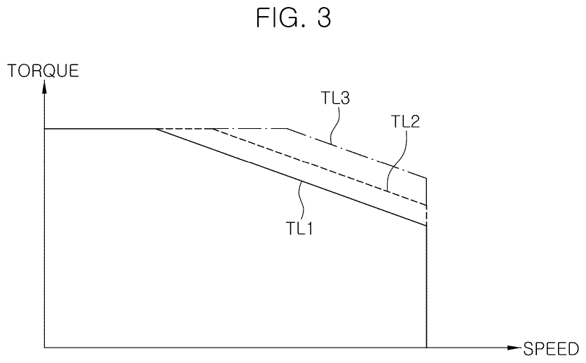

Such drive modes are related to an output limit, and torques that the first motor 110 and the second motor 120 may output vary depending on the drive mode. This will be described below with reference to FIGS. 2 and 3.

FIG. 2 is a view showing an output limit curve of a motor according to an embodiment of the present disclosure. FIG. 3 is a view showing a torque limit curve of the motor according to an embodiment of the present disclosure.

First, referring to FIG. 2, an output limit curve of the first motor 110 or the second motor 120 is illustrated as a graph with output and speed as axes. Compared to an output limit curve (OL1) of the first drive mode, an output limit curve (OL2) of the second drive mode has an equal or higher output value at an equal speed.

Referring to FIG. 3, a torque limit curve of the first motor 110 or the second motor 120 is illustrated as a graph with torque and speed as axes. Compared to a torque limit curve (TL1) of the first drive mode, a torque limit curve (TL2) of the second drive mode has an equal or higher torque value at an equal speed.

The first motor 110 and the second motor 120 may be driven in the first drive mode for efficient driving in a low output section, and may be driven in the second drive mode to increase a driving force in a high output section.

As described above, present output limits of the first motor 110 and the second motor 120 may be determined based on the drive mode currently being applied. For example, the present output limit of the first motor 110 driven in the first drive mode may correspond to the output limit in the first drive mode, which is the CEW mode, and the present output limit of the first motor 110 driven in the second drive mode may correspond to the output limit in the second drive mode, which is the OEW mode. The same is true for the second motor 120.

In addition, while the first motor 110 and the second motor 120 are already being driven in the second drive mode for high output, the torque command is increased through torque vectoring. If the increased torque command exceeds the output limit of the second drive mode, the output limit may be increased to exceed the output limit of the second drive mode. Such an increase in the output limit beyond the output limit of the second drive mode may be referred to as a boost mode.

In FIGS. 2 and 3, an output limit curve (OL3) of the boost mode has an equal or higher output value at an equal speed, compared to the output limit curve (OL2) of the second drive mode, and a torque limit curve (TL3) of the boost mode has an equal or higher torque value at an equal speed, compared to the torque limit curve (TL2) of the second drive mode. Thus, even when a torque command is adjusted upward according to torque vectoring such that the torque command exceeds the output limit of the second drive mode, the first motor 110 or the second motor 120 with the increased torque command may output torque that satisfies the torque command.

While the first motor 110 and the second motor 120 are being driven in the first drive mode rather than the second drive mode, the output limit may be increased when the torque command adjusted according to torque vectoring exceeds the output limit of the first drive mode. In this case, the output limit may be increased through switching to the second drive mode.

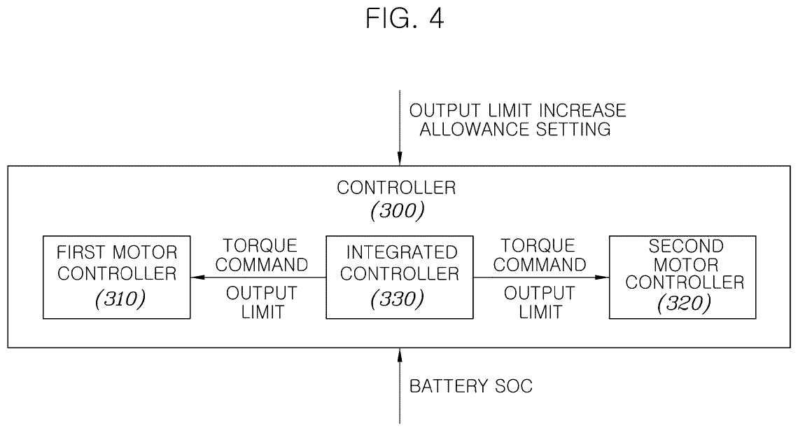

Hereinafter, referring to FIG. 4, a configuration of the controller 300, according to an embodiment of the present disclosure, will be described in detail.

FIG. 4 is a view showing a detailed configuration of a controller according to an embodiment of the present disclosure.

Referring to FIG. 4, the controller 300 may include a first motor controller 310, a second motor controller 320, and an integrated controller 330, and may receive a request to increase an output limit and an input of an SOC of a battery connected to the first inverter unit 210 and the second inverter unit 220.

In this case, an output limit increase allowance setting may be input through a device, such as an AVNT device, which is connected to the controller 300 and is capable of interfacing with the vehicle user; and the SOC of the battery may be input from a separate controller, such as a battery management system (BMS), which is connected to the controller 300.

The first motor controller 310 and the second motor controller 320 control driving of the first motor 110 and the second motor 120 through the first inverter unit 210 and the second inverter unit 220, respectively. Such driving control may be performed based on a torque command and an output limit for each of the first motor 110 and the second motor 120.

The integrated controller 330 generates a torque command for each of the first motor 110 and the second motor 120, and may perform torque vectoring to adjust the torque command. In addition, the integrated controller 330 may determine whether output limit increase conditions are satisfied based on the input output limit increase allowance setting and battery SOC and the like, and may adjust the output limit based on the torque command adjusted according to torque vectoring and a present output limit of the first motor 110 and the second motor 120. The torque command and the output limit determined by the integrated controller 330 as described above are transmitted to the first motor controller 310 and the second motor controller 320, respectively.

In implementation, the controller 300 may be implemented as a combination of a plurality of controllers. For example, the first motor controller 310 and the second motor controller 320 may each be implemented as a separate motor control unit (MCU), or may be implemented as functions of a single motor control unit (MCU). The integrated controller 330 may be implemented as a higher-level control unit than a motor control unit (MCU), such as a vehicle control unit (VCU), a hybrid control unit (HCU), or the like.

Hereinafter, a process of controlling the motor driving apparatus described so far will be described with reference to a flowchart.

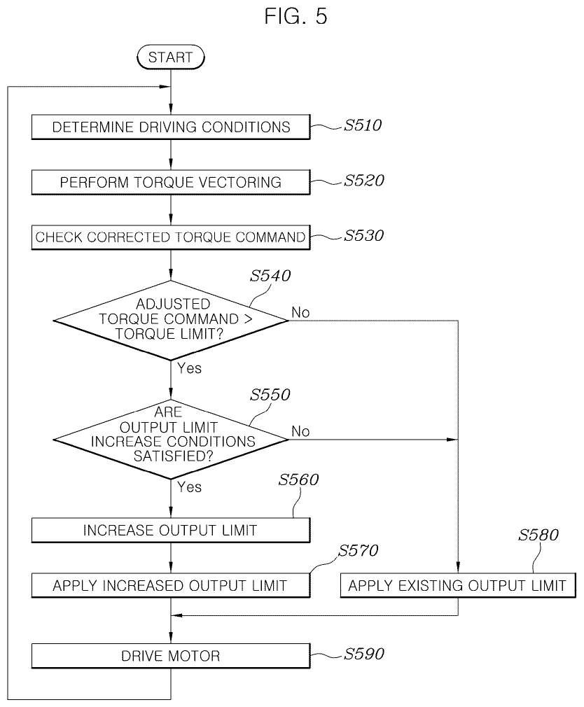

FIG. 5 is a flowchart describing a method for controlling the motor driving apparatus according to an embodiment of the present disclosure.

Referring to FIG. 5, the controller 300 may determine driving conditions, including a torque command according to a required output of the vehicle, a steering angle of the vehicle, a speed of the vehicle, a surface condition of a road on which the vehicle is driving and the like (S510), and may perform torque vectoring to adjust a torque command for the first motor 110 or the second motor 120 based on the driving conditions (S520).

Next, the controller 300 checks the torque command adjusted according to torque vectoring (S530). If the adjusted torque command exceeds a current torque limit (Yes in S540), the controller 300 determines whether output limit increase conditions are satisfied (S550). If the output limit increase conditions are determined to be satisfied (Yes in S550), the controller 300 increases the output limit (S560), applies the increased output limit (S570) to control driving of the motor based on the adjusted torque command (S590).

On the other hand, if the torque command adjusted according to torque vectoring is below or equal to the current torque limit (No in S540), or if the output limit increase conditions are not satisfied (No in S550) even when the adjusted torque command exceeds the current torque limit (Yes in S540), the existing output limit is applied (S580) to control driving of the motor (S590), instead of adjusting the output limit.

Among the process described above, the adjusting of the output limit after performing torque vectoring (S530-S570) may be performed for each of the first motor 110 and the second motor 120. Alternatively, the adjusting may be performed for any one of the first motor 110 and the second motor 120, in particular, only for a motor with a torque command adjusted upward according to torque vectoring.

According to various embodiments of the present disclosure as described above, torque vectoring may be implemented without a separate device for controlling torque vectoring by driving the left and right wheels of the vehicle separately through the plurality of motors.

In particular, by adjusting the output limit of the motor itself, torque vectoring may be performed normally without a separate device even in a situation requiring high output, thereby improving steering control performance of the vehicle.

Although the specific embodiments of the present disclosure have been described and illustrated, those skilled in the art will appreciate that various alternations and modifications are possible without departing from the technical spirit of the present disclosure provided in the following claims.

What is claimed is:

1. A motor driving apparatus comprising:
a first motor and a second motor, each independently driving a left wheel and a right wheel of a vehicle;
a first inverter unit driving the first motor through at least one inverter and a second inverter unit driving the second motor through at least one inverter; and
a controller controlling the first inverter unit and the second inverter unit based on a torque command and an output limit for each of the first motor and the second motor, wherein the controller performs torque vectoring to drive the left wheel and the right wheel with different torques by adjusting the torque command for at least one of the first motor and the second motor.

2. The motor driving apparatus of claim 1, wherein the controller performs the torque vectoring based on at least one of a torque command according to a required output of the vehicle, a steering angle of the vehicle, and a speed of the vehicle.

3. The motor driving apparatus of claim 2, wherein the controller performs the torque vectoring by adjusting the torque command for at least one of the first motor and the second motor by further considering a surface condition of a road on which the vehicle is driving.

4. The motor driving apparatus of claim 1, wherein the controller adjusts the output limit for the first motor based on the torque command, adjusted through the torque vectoring, for the first motor and on a present output limit for the first motor.

5. The motor driving apparatus of claim 1, wherein the controller adjusts the output limit for the second motor based on the torque command, adjusted through the torque vectoring, for the second motor and on a present output limit for the second motor.

6. The motor driving apparatus of claim 1, wherein the controller increases the output limit for a motor, among the first motor and the second motor, with a torque command adjusted upward through the torque vectoring, based on the adjusted torque command and the present output limit.

7. The motor driving apparatus of claim 6, wherein the controller maintains the increased output limit for a preset period of time and restores the increased output limit to a level before the increasing when the preset period of time elapses.

8. The motor driving apparatus of claim 6, wherein the controller increases the output limit when output limit increase conditions, including an output limit increase allowance setting, are satisfied.

9. The motor driving apparatus of claim 1, wherein the first inverter unit and the second inverter unit each include a plurality of inverters, and drive the first motor and the second motor through one or all of the plurality of inverters based on a drive mode of each of the first motor and the second motor, respectively.

10. The motor driving apparatus of claim 9, wherein the output limit is determined based on the drive mode.

11. A method for controlling a motor driving apparatus, the method comprising:
controlling, by a controller, a first inverter unit driving a first motor through at least one inverter and a second inverter unit driving a second motor through at least one inverter based on a torque command and an output limit for each of the first motor and the second motor, each independently driving a left wheel and a right wheel of a vehicle; and
performing torque vectoring, by the controller, to drive the left wheel and the right wheel with different torques by adjusting the torque command for at least one of the first motor and the second motor.

12. The method of claim 11, wherein the performing of torque vectoring comprises performing the torque vectoring based on at least one of a torque command according to a required output of the vehicle, a steering angle of the vehicle, and a speed of the vehicle.

13. The method of claim 12, wherein the performing of torque vectoring comprises performing the torque vectoring by adjusting the torque command for at least one of the first motor and the second motor by further considering a surface condition of a road on which the vehicle is driving.

14. The method of claim 11, further comprising: adjusting, by the controller, the output limit for the first motor based on the torque command, adjusted through the torque vectoring, for the first motor and on a present output limit for the first motor.

15. The method of claim 11, further comprising: adjusting, by the controller, the output limit for the second motor based on the torque command, adjusted through the torque vectoring, for the second motor and on a present output limit for the second motor.

16. The method of claim 11, further comprising: increasing, by the controller, the output limit for a motor, among the first motor and the second motor, with a torque command adjusted upward through the torque vectoring, based on the adjusted torque command and the present output limit.

17. The method of claim 16, further comprising: maintaining the increased output limit for a preset period of time and restoring the increased output limit to a level before the increasing when the preset period of time elapses.

18. The method of claim 16, wherein the increasing of the output limit comprises increasing the output limit when output limit increase conditions, including an output limit increase allowance setting, are satisfied.

19. The method of claim 11, wherein the first inverter unit and the second inverter unit each comprise a plurality of inverters, and drive the first motor and the second motor through one or all of the plurality of inverters based on a drive mode of each of the first motor and the second motor, respectively.

20. The method of claim 19, wherein the output limit is determined based on the drive mode.
